(19) United States
(12) Patent Application Publication
(10) Pub. No.: US 2022/0383463 A1
(43) Pub. Date: Dec. 1, 2022

(54) METHOD AND DEVICE FOR IMAGE FUSION, COMPUTING PROCESSING DEVICE, AND STORAGE MEDIUM

(71) Applicant: MEGVII (BEIJING) TECHNOLOGY CO., LTD., Beijing (CN)

(72) Inventors: Tao WANG, Beijing (CN); Xueqin CHEN, Beijing (CN)

(21) Appl. No.: 17/762,532

(22) PCT Filed: Jul. 31, 2020
(86) PCT No.: PCT/CN2020/106295

§ 371 Date: Mar. 22, 2022

(30) Foreign Application Priority Data
Oct. 12, 2019 (CN) 201910967375.8

(51) Int. Cl. G06T 5/50; G06T 7/11; G06T 5/00; G06V 10/75; G06V 10/22

(52) U.S. Cl. CPC G06T 5/50; G06T 7/11; G06T 5/002; G06V 10/751; G06V 10/22; G06T 2207/20021; G06T 2207/20221; G06T 2207/10144

(57) ABSTRACT

The present application relates to an image-fusion method and apparatus, a computing and processing device and a storage medium. The method includes: based on a same one target scene, acquiring a plurality of exposed images of different exposure degrees; acquiring a first exposed-image fusion-weight diagram corresponding to each of the exposed images, wherein the first exposed-image fusion-weight diagram contains fusion weights corresponding to pixel points of the exposed image; acquiring a region area of each of overexposed regions in each of the exposed images; for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and according to each of the second exposed-image fusion-weight diagrams, performing image-fusion processing to the plurality of exposed images, to obtain a fused image. Accordingly, the present application can balance the characteristics of the different overexposed regions, and prevent the losing of the details of the small overexposed regions, to enable the obtained fused image to be more realistic.

The present application claims the priority of the Chinese patent application filed on Oct. 12, 2019 before the Chinese Patent Office with the application number of 201910967375.8 and the title of “METHOD AND DEVICE FOR IMAGE FUSION, COMPUTING PROCESSING DEVICE, AND STORAGE MEDIUM”, which is incorporated herein in its entirety by reference.

### TECHNICAL FIELD

The present application relates to the technical field of image processing, and particularly relates to an image-fusion method and apparatus, a computing and processing device and a storage medium.

### BACKGROUND

With the development of the technique of image processing, the obtaining of a high-quality image by fusing images of different exposure degrees has become a research hotspot in the field of image processing. In the conventional technique, multiple images of different exposure values are usually used to obtain a fused image by direct fusion based on a certain rule.

However, due to different edge information and brightness variations exist in the different exposed images, the direct fusion to the images may easily cause missing of the details of the small overexposed regions.

### SUMMARY

In view of that, regarding the above technical problems, there is provided an image-fusion method and apparatus, a computing and processing device and a storage medium.

An image-fusion method, wherein the method includes:

based on a same one target scene, acquiring a plurality of exposed images of different exposure degrees;

acquiring a first exposed-image fusion-weight diagram corresponding to each of the exposed images, wherein the first exposed-image fusion-weight diagram includes fusion weights corresponding to pixel points of the exposed image;

acquiring a region area of each of overexposed regions in each of the exposed images;

for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and

according to each of the second exposed-image fusion-weight diagrams, performing an image-fusion processing to the plurality of exposed images, to obtain a fused image.

In an embodiment, the step of acquiring the first exposed-image fusion-weight diagram corresponding to each of the exposed images includes:

for each of the exposed images, according to differences between pixel values of the pixel points of the exposed image and a preset reference pixel value, obtaining the first exposed-image fusion-weight diagram.

In an embodiment, the step of, according to the differences between the pixel values of the pixel points of the exposed image and the preset reference pixel value, obtaining the first exposed-image fusion-weight diagram includes:

calculating the differences between the pixel values of the pixel points of the exposed image and the preset reference pixel value; and

according to ratios of the differences to the preset reference pixel value, obtaining the first exposed-image fusion-weight diagram, wherein if the difference corresponding to a pixel point in the exposed image is larger, the fusion weight corresponding to the pixel point in the first exposed-image fusion-weight diagram is lower.

In an embodiment, the step of acquiring the region area of each of the overexposed regions in each of the exposed images includes:

performing overexposed-region detection to each of the exposed images, to obtain an overexposed-region mask diagram corresponding to each of the exposed images;

according to each of the overexposed-region mask diagrams, performing region segmentation to the exposed image corresponding to the overexposed-region mask diagram, to obtain a corresponding overexposed region; and

acquiring a region area of each of overexposed regions in each of the exposed images.

In an embodiment, the step of, by using the region area of each of the overexposed regions in the exposed image, performing smoothing filtering to the first exposed-image fusion-weight diagram corresponding to the exposed image, to obtain the second exposed-image fusion-weight diagram corresponding to the exposed image includes:

according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

In an embodiment, the step of, according to the preset correspondence relation between the areas of the overexposed regions and the smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image includes:

according to the correspondence relation, obtaining smoothing coefficients corresponding to the region areas of each of the overexposed regions in the exposed image; and

according to the smoothing coefficients corresponding to the region areas of each of the overexposed regions in the exposed image, performing smoothing filtering to the first exposed-image fusion-weight diagram corresponding to the exposed image, to obtain a second exposed-image fusion-weight diagram corresponding to the exposed image.

In an embodiment, before the step of, according to each of the second exposed-image fusion-weight diagrams, performing image-fusion processing to the plurality of exposed images, to obtain the fused image, the method further includes:

by using a preset numerical value as a filtering radius, performing smoothing filtering to the second exposed-image fusion-weight diagram, to obtain a second exposed-image fusion-weight diagram that has been updated, wherein the preset numerical value is less than a preset threshold.

In an embodiment, the step of, according to each of the second exposed-image fusion-weight diagrams, performing image-fusion processing to the plurality of exposed images, to obtain the fused image includes:

according to the fusion weights corresponding to the pixel points in each of the second exposed-image fusion-weight diagrams, performing weighted summation to the plurality of exposed images, to obtain the fused image.

An image-fusion apparatus, wherein the apparatus includes:

an image acquiring module configured for, based on a same one target scene, acquiring a plurality of exposed images of different exposure degrees;

a first-weight acquiring module configured for acquiring a first exposed-image fusion-weight diagram corresponding to each of the exposed images, wherein the first exposed-image fusion-weight diagram includes fusion weights corresponding to pixel points of the exposed image;

a region-area acquiring module configured for acquiring a region area of each of overexposed regions in each of the exposed images;

a second-weight acquiring module configured for, for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and

an image fusing module configured for, according to each of the second exposed-image fusion-weight diagrams, performing image-fusion processing to the plurality of exposed images, to obtain a fused image.

A computing and processing device, wherein the computing and processing device includes:

a memory storing a computer-readable code; and

one or more processors, wherein when the computer-readable code is executed by the one or more processors, the computing and processing device implements the image-fusion method according to any one of the above items.

A computer program, wherein the computer program includes a computer-readable code, and when the computer-readable code is executed in a computing and processing device, the computer-readable code causes the computing and processing device to implement the image-fusion method according to any one of the above items.

A computer-readable storage medium, wherein the computer-readable storage medium stores the computer program stated above, and the computer program, when executed by a processor, implements the steps of any one of the methods stated above.

In the image-fusion method and apparatus, the computing and processing device and the storage medium, the method includes, based on a same one target scene, acquiring a plurality of exposed images of different exposure degrees; subsequently, acquiring a first exposed-image fusion-weight diagram corresponding to each of the exposed images, wherein the first exposed-image fusion-weight diagram includes fusion weights corresponding to pixel points of the exposed image; further, acquiring a region area of each of overexposed regions in each of the exposed images, and for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and, finally, according to each of the second exposed-image fusion-weight diagrams, performing image-fusion processing to the plurality of exposed images, to obtain a fused image. By using the region area of each of the overexposed regions in the exposed image, performing smoothing filtering to the first exposed-image fusion-weight diagram corresponding to the exposed image, the present application can balance the characteristics of the different overexposed regions of each of the exposed images in the image fusion, and prevent the missing of the details of the small overexposed regions, to enable the obtained fused image to be more realistic.

The above description is merely a summary of the technical solutions of the present application. In order to more clearly know the elements of the present application to enable the implementation according to the contents of the description, and in order to make the above and other purposes, features and advantages of the present application more apparent and understandable, the particular embodiments of the present application are provided below.

### BRIEF DESCRIPTION OF THE DRAWINGS

In order to more clearly illustrate the technical solutions of the embodiments of the present application or the prior art, the figures that are required to describe the embodiments or the prior art will be briefly introduced below. Apparently, the figures that are described below are embodiments of the present application, and a person skilled in the art can obtain other figures according to these figures without paying creative work.

FIG. 1 is a schematic flow chart of the image-fusion method according to an embodiment;

FIG. 2 is a schematic flow chart of an implementation of the step S200 according to an embodiment;

FIG. 3 is a schematic flow chart of an implementation of the step S300 according to an embodiment;

FIG. 4 is a schematic flow chart of an implementation of the step S400 according to an embodiment;

FIG. 5 is a structural block diagram of the image-fusion apparatus according to an embodiment; and

FIG. 6 is an internal structural diagram of the computing and processing device according to an embodiment.

### DETAILED DESCRIPTION OF THE EMBODIMENTS

In order to make the objects, the technical solutions and the advantages of the present application clearer, the present application will be described in further detail below with reference to the drawings and the embodiments. It should be understood that the particular embodiments described herein are merely intended to interpret the present application, and are not intended to limit the present application. All of the other embodiments that a person skilled in the art obtains on the basis of the embodiments of the present application without paying creative work fall within the protection scope of the present application.

It can be understood that the terms such as “first” and “second” used in the present application may be used to describe various conditional relations herein, but those conditional relations are not limited by those terms. Those terms are merely intended to distinguish one conditional relation from another conditional relation.

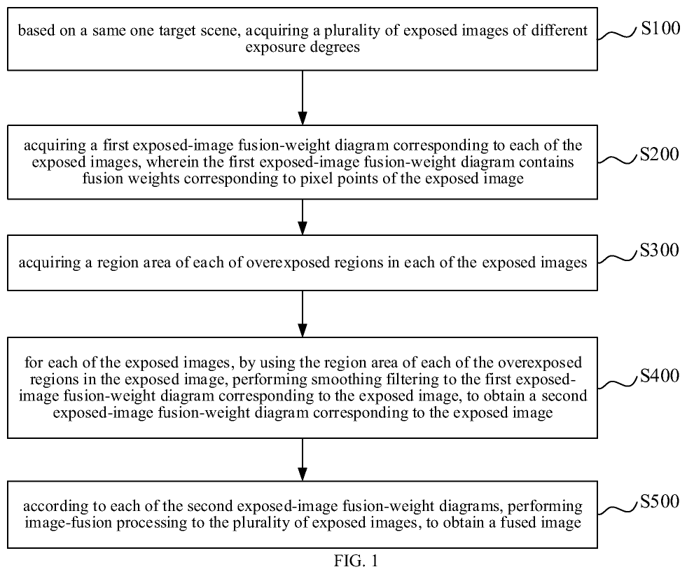

In an embodiment, as shown in FIG. 1, an image-fusion method is provided, wherein the method includes the following steps:

Step S100: based on a same one target scene, acquiring a plurality of exposed images of different exposure degrees.

Wherein, the target scene refers to a scene of which the images of the different exposure degrees are acquired.

Particularly, regarding the same one target scene, with different exposure values, a plurality of exposed images of different exposure degrees are acquired.

Step S200: acquiring a first exposed-image fusion-weight diagram corresponding to each of the exposed images, wherein the first exposed-image fusion-weight diagram includes fusion weights corresponding to pixel points of the exposed image.

Wherein, the image fusion refers to an image data with respect to the same one target collected by multiple channels, after such an image processing and a computer technical processing and so forth, to maximally extract usable information from each of the channels, and finally integrating into a high-quality image, to improve the utilization ratio of the image information, improve the accuracy and the reliability of the computerized interpretation, increase the spatial resolution and the spectral resolution of the original image, and facilitate the monitoring.

The first exposed-image fusion-weight diagram refers to a distribution graph that is formed by the values of the fusion weights corresponding to the pixel points of a plurality of exposed images when the plurality of exposed images are fused.

Step S300: acquiring a region area of each of overexposed regions in each of the exposed images.

Wherein, overexposure refers to a case in which the brightness in the acquired image is too high for various reasons. A serious overexposure results in that the frames in the image are whitish, and a large quantity of the image details are lost. Particularly, in the present application, one or more overexposed regions may exist in each of the exposed images.

Particularly, according to the actual requirements on the qualities of the pictures, a brightness value may be preset. For example, the brightness value is preset to be 240, and when all of the pixel values in a certain region of an exposed image are greater than 240, that region is considered to be an overexposed region. A plurality of discontinuous overexposed regions may exist in the same exposed image.

Step S400: for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image.

Particularly, if the exposed images of the different exposure values are directly fused according to the first exposed-image fusion-weight diagram obtained in the step S200, an unnatural light halo may appear, which make the transition in the image fusion very unnatural. In order to prevent the unnatural light halo, if total-diagram smoothing filtering is performed directly to the first exposed-image fusion-weight diagram, and further the image fusion is performed according to the first exposed-image fusion-weight diagram obtained after the total-diagram smoothing filtering, although the obtained fused image can prevent the unnatural light halo to a certain extent, but, at the same time, the detail exhibition of the small overexposed regions may be neglected, or even the small regions are entirely neglected, which results in the missing of the details of the small overexposed regions. Therefore, due to one or more overexposed regions may exist in each of the exposed images, and the areas of the overexposed regions are different, it is necessary to perform a subdivision operation with respect to the areas of the different overexposed regions before the image fusion. First, the area of at least one of the overexposed regions of each of the exposed images is acquired, and subsequently, by using the region area of each of the overexposed regions in the exposed image and the first exposed-image fusion-weight diagram corresponding to the exposed image to perform smoothing filtering, and a second exposed-image fusion-weight diagram can be obtained.

Step S500: according to each of the second exposed-image fusion-weight diagrams, performing image-fusion processing to the plurality of exposed images, to obtain a fused image.

Particularly, in the present application, the exposed images of different exposure values are fused by using the second exposed-image fusion-weight diagram obtained after the region area of each of the overexposed regions in the exposed image in the step S400, which can effectively prevent the missing of the details of the small overexposed regions, and maintain the texture information of the small overexposed regions.

In the above-described image-fusion method, based on a same one target scene, acquiring a plurality of exposed images of different exposure degrees; subsequently, acquiring a first exposed-image fusion-weight diagram corresponding to each of the exposed images, wherein the first exposed-image fusion-weight diagram includes fusion weights corresponding to pixel points of the exposed image; further, acquiring a region area of each of overexposed regions in each of the exposed images, and for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and, finally, according to each of the second exposed-image fusion-weight diagrams, performing image-fusion processing to the plurality of exposed images, to obtain a fused image. By using the region area of each of the overexposed regions in the exposed image, performing smoothing filtering to the first exposed-image fusion-weight diagram corresponding to the exposed image, the present application can balance the characteristics of the different overexposed regions of each of the exposed images in the image fusion, and prevent the missing of the details of the small overexposed regions, to enable the obtained fused image to be more realistic.

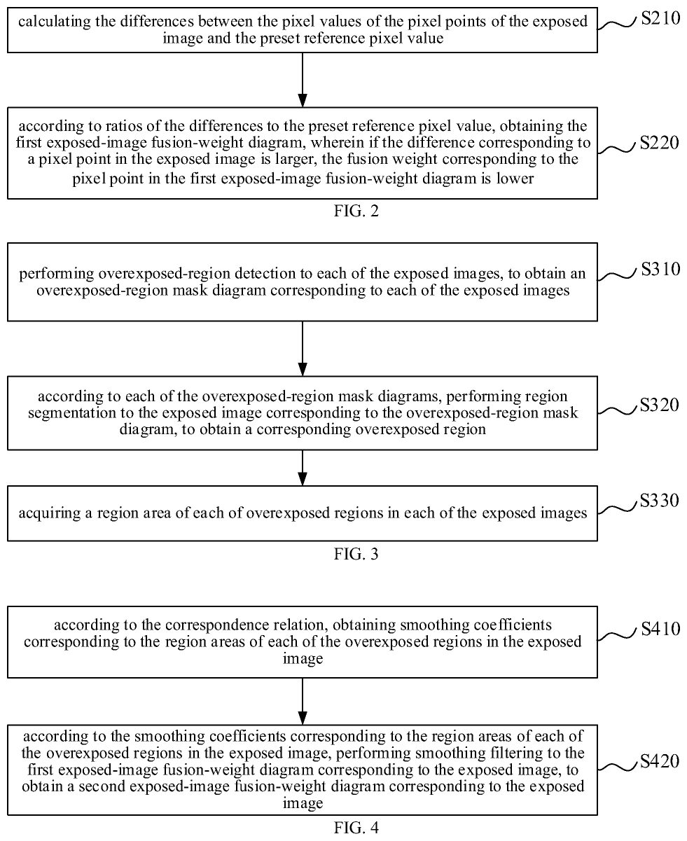

In an embodiment, as shown in FIG. 2, FIG. 2 is a schematic flow chart of an implementation of the step S200. The step S200 of acquiring the first exposed-image fusion-weight diagram corresponding to each of the exposed images includes:

for each of the exposed images, according to differences between pixel values of the pixel points of the exposed image and a preset reference pixel value, obtaining the first exposed-image fusion-weight diagram.

Particularly, each of the pixel points of each of the exposed images corresponds to a pixel value (gray-scale value). According to the differences between each of the pixel values and a preset reference pixel value, an exposed-image fusion-weight diagram can be obtained, and that exposed-image fusion-weight diagram is determined to be the first exposed-image fusion-weight diagram.

The particular steps of, for each of the exposed images, acquiring the first exposed-image fusion-weight diagram are as follows:

Step S210: calculating the differences between the pixel values of the pixel points of the exposed image and the preset reference pixel value.

Particularly, each of the exposed images corresponds to a plurality of pixel points, and by calculating the differences between the pixel values corresponding to each of the pixel points of the exposed image and the preset reference pixel value, a group of differences can be obtained. The explanations can be made by using a simple example, a 3*3 exposed image with the corresponding pixel values of (138, 148, 158; 148, 158, 168; 158, 168, 178), and assuming that the preset reference pixel value is 128, then the corresponding pixel differences are (138-128, 148-128, 158-128; 148-128, 158-128, 168-128; 158-128, 168-128, 178-128)=(10, 20, 30; 20, 30, 40; 30, 40, 50). Certainly, here the example of the 3*3 exposed image is taken for illustration, and the images practically processed are usually very large, but the corresponding calculating mode is the same, and is not explained in detail herein.

Step S220: according to ratios of the differences to the preset reference pixel value, obtaining the first exposed-image fusion-weight diagram, wherein if the difference corresponding to a pixel point in the exposed image is higher, the fusion weight corresponding to the pixel point in the first exposed-image fusion-weight diagram is lower.

Particularly, after obtaining the pixel differences in the step S210, the first exposed-image fusion-weight diagram may be directly obtained according to the ratios of each of the pixel differences to the preset reference pixel value. The purpose of obtaining the ratios of each of the differences to the preset reference pixel value is to perform normalization processing to the obtained weights. If the difference corresponding to a pixel point in the exposed image is higher, that indicates that the difference between the pixel value of the pixel point and the preset reference pixel value is higher, and the higher difference indicates a higher degree of distortion. Therefore, in the image fusion, the fusion weight corresponding to the pixel point is lower, which can solve the problem of the natural transition of the regions in the image fusion. For example, the differences corresponding to the pixel points in an exposed image are (10, 20, 30; 20, 30, 40; 30, 40, 50)/128=(10/128, 20/128, 30/128; 20/128, 30/128, 40/128; 30/128, 40/128, 50/128). After reversing the first exposed-image fusion-weight diagram by using the numerical value 1, at this point the first exposed-image fusion-weight diagram is expressed as (1-10/128, 1-20/128, 1-30/128; 1-20/128, 1-30/128, 1-40/128; 1-30/128, 1-40/128, 1-50/128). Optionally, the first exposed-image fusion-weight diagram may also be acquired by using another weight calculating mode according to the property of the practically processed image and user demands, which is not particularly limited herein.

In the above embodiments, by calculating the differences between the pixel values corresponding to each of the pixel points of the exposed image and the preset reference pixel value, and according to the ratios of the differences to the preset reference pixel value, the first exposed-image fusion-weight diagram is obtained, wherein if the difference corresponding to a pixel point in the exposed image is higher, the fusion weight corresponding to the pixel point in the first exposed-image fusion-weight diagram is lower. The first exposed-image fusion-weight diagrams are determined according to the ratios of the differences between the pixel values of the pixel points of the different exposed images and the preset reference pixel value to the preset reference pixel value, the characteristics included by each of the exposed images can maximize the useful information of each of the exposed images.

In an embodiment, as shown in FIG. 3, FIG. 3 is a schematic flow chart of an implementation of the step S300. The step S300 of acquiring the region area of each of the overexposed regions in each of the exposed images includes:

Step S310: performing overexposed-region detection to each of the exposed images, to obtain an overexposed-region mask diagram corresponding to each of the exposed images.

Particularly, the binary 0 and 1 are taken as an example for illustration. In the overexposed-region detection on the exposed images, if a detected pixel point is an overexposed point, then it is represented by 1, if a detected pixel point is a non-overexposed point, then it is represented by 0, and the final detection results are used as the overexposed-region mask diagram. That will be explained by using a simple example. In a 3*3 exposed image, when the brightness value of a detected point is greater than a given preset threshold, then it is considered to be an overexposed point, and when the brightness value of a detected point is less than or equal to the given preset threshold, then it is considered to be a non-overexposed point. When the actual exposed image is expressed as (overexposed point, overexposed point, overexposed point; overexposed point, overexposed point, non-overexposed point; overexposed point, overexposed point, non-overexposed point), the corresponding overexposed-region mask diagram may be expressed as (1, 1, 1; 1, 1, 0; 1, 0, 0). Certainly, here the example of the 3*3 exposed image is taken for illustration, and the images practically processed are usually very large, but the corresponding calculating mode is the same, and is not explained in detail herein.

Step S320: according to each of the overexposed-region mask diagrams, performing region segmentation to the exposed image corresponding to the overexposed-region mask diagram, to obtain a corresponding overexposed region.

Particularly, according to the overexposed-region mask diagram obtained in the step S310, it can be known that the top left corner of the overexposed-region mask diagram is full of “1”, which indicates that the top left corner of the corresponding exposed image is an overexposed region. Likewise, it can be obtained that the bottom right corner of the overexposed-region mask diagram is full of “0”, which indicates that the bottom right corner of the corresponding exposed image is a non-overexposed region. By performing region segmentation to the image regions in the overexposed-region mask diagram which numerical value is “1”, the corresponding overexposed regions can be obtained. The overexposed-region mask diagram may undergo region segmentation by using a pixel-neighborhood reading-through method (the particular algorithm of the region segmentation is not limited herein), to obtain the corresponding overexposed regions. For example, the above-described 3*3 exposed image is segmented by using the pixel-neighborhood reading-through method, to obtain an overexposed region. Certainly, a plurality of overexposed regions my exist in the exposed image.

Step S330: acquiring a region area of each of overexposed regions in each of the exposed images.

Particularly, after obtaining the overexposed regions in the step S320, the area of each of the overexposed regions is calculated, and the region area of each of the overexposed regions in each of the exposed images can be obtained.

In the above embodiments, by performing overexposed-region detection to each of the exposed images, to obtain an overexposed-region mask diagram corresponding to each of the exposed images; subsequently, according to each of the overexposed-region mask diagrams, performing region segmentation to the exposed image corresponding to the overexposed-region mask diagram, to obtain the corresponding overexposed regions; and, finally, acquiring a region area of each of overexposed regions in each of the exposed images. The calculation of the area of each of the overexposed regions in each of the exposed images can facilitate the subsequent fusion processing to the images according to the areas of the different overexposed regions, which can enable the acquired fused image to balance the characteristics of the different overexposed regions of each of the overexposed images at the same time, and prevent the loss of the details of the small overexposed regions, and maintain the texture information of the small overexposed regions.

In an embodiment, in an implementation of the step S400, the step S400 of, for each of the exposed images, by using the region area of each of the overexposed regions in the exposed image, performing smoothing filtering to the first exposed-image fusion-weight diagram corresponding to the exposed image, to obtain the second exposed-image fusion-weight diagram corresponding to the exposed image includes:

according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

Wherein, the smoothing coefficient is a coefficient in the smoothing method. The smoothing coefficient decides the level of the smoothing and the response speed to the difference between a predicted value and the actual result. If the smoothing coefficient is closer to 1, the degree of the influence by the actual value on the smoothed value descends more quickly, and if the smoothing coefficient is closer to 0, the degree of the influence by the actual value on the smoothed value descends more slowly. According to the characteristics of the smoothing coefficient, in the present application, when the region area is smaller, a lower smoothing coefficient may be used, and when the region area is larger, a higher smoothing coefficient may be used, to maintain the details of the image when the region area is smaller. Optionally, the square root of the area of the current overexposed region may also be used as the smoothing coefficient.

Particularly, a correspondence relation exists between the areas of the overexposed regions and the smoothing coefficients, and the correspondence relation may be preset in a processor according to actual demands. According to the preset correspondence relation and the region areas of each of the overexposed regions, a group of smoothing coefficients can be obtained, and, by performing smoothing filtering to the first exposed-image fusion-weight diagram according to the obtained smoothing coefficients, the second exposed-image fusion-weight diagram can be obtained. For example, the smoothing filtering may be implemented by Gaussian Blur, in which case the smoothing coefficient obtained above may be used as the radius of the Gaussian Blur. The above is merely an implementation of the smoothing filtering, and the particular mode of the smoothing filtering is not limited herein.

In an embodiment, as shown in FIG. 4, FIG. 4 is a schematic flow chart of an implementation of the step S400. The step of, according to the preset correspondence relation between the areas of the overexposed regions and the smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image includes:

Step S410: according to the correspondence relation, obtaining smoothing coefficients corresponding to the region areas of each of the overexposed regions in the exposed image.

Particularly, the area values corresponding to the areas of the overexposed regions are looked up in the preset correspondence relation, and, according to the looked-up area values and the correspondence relation, the smoothing coefficients corresponding to the region areas of each of the overexposed regions in the exposed image are obtained. In the same manner, the smoothing coefficients corresponding to the areas of all of the overexposed regions in each of the exposed images can be obtained.

Step S420: according to the smoothing coefficients corresponding to the region areas of each of the overexposed regions in the exposed image, performing smoothing filtering to the first exposed-image fusion-weight diagram corresponding to the exposed image, to obtain a second exposed-image fusion-weight diagram corresponding to the exposed image.

Particularly, by performing smoothing filtering to the first exposed-image fusion-weight diagram corresponding to the exposed image according to the smoothing coefficient obtained in the step S410, the second exposed-image fusion-weight diagram can be obtained. For example, when the weight distribution in the first exposed-image fusion-weight diagram is (0.1, 0.05, 0.08; 0.1, 0.06, 0.9; 0.09, 0.1, 0.12), it can be obviously seen that the weight 0.9 is a singular value, and different filtering results can be obtained by using different filtering modes. However, the filtering results are generally within a certain range, and the distribution of the second exposed-image fusion-weight diagram obtained after the filtering might be (0.1, 0.05, 0.08; 0.1, 0.06, 0.1; 0.09, 0.1, 0.12). Certainly, the above description is an obvious example, and when an imperceptible weight value exists among the weights, the above method may be used to perform smoothing filtering to the first exposed-image fusion-weight diagram, to obtain the second exposed-image fusion-weight diagram.

In the above embodiments, the method includes, according to the correspondence relation, obtaining smoothing coefficients corresponding to the region areas of each of the overexposed regions in the exposed image; and according to the smoothing coefficients corresponding to the region areas of each of the overexposed regions in the exposed image, performing smoothing filtering to the first exposed-image fusion-weight diagram corresponding to the exposed image, to obtain a second exposed-image fusion-weight diagram corresponding to the exposed image. The process of acquiring the second exposed-image fusion-weight diagram can balance the characteristics of the different overexposed regions of each of the overexposed images at the same time, prevent the missing of the details of the small overexposed regions, and maintain the texture information of the small overexposed regions, to obtain a fused image that is more realistic.

In an embodiment, before the step S500 of, according to each of the second exposed-image fusion-weight diagrams, performing image-fusion processing to the plurality of exposed images, to obtain the fused image, the method further includes:

by using a preset numerical value as a filtering radius, performing smoothing filtering to the second exposed-image fusion-weight diagram, to obtain a second updated exposed-image fusion-weight diagram, wherein the preset numerical value is less than a preset threshold.

Particularly, when the first exposed-image fusion-weight diagram is filtered according to the areas of the overexposed regions, a certain boundary effect may be caused. Therefore, by using a numerical value less than a preset threshold as the filtering radius, to perform smoothing filtering to the entire obtained second exposed-image fusion-weight diagram, the boundary effect, which may exist in the above-described processing process, can be prevented, to enable the fused image obtained according to the second exposed-image fusion-weight diagrams to be more realistic. Here, the preset numerical value less than the preset threshold may be set to be 3*3, 5*5 or another low numerical value, and by performing smoothing filtering to the second exposed-image fusion-weight diagram by using such a numerical value as the filtering radius, the boundary effect that might exist can be eliminated. However, when the preset numerical value is high, blurry transition between the different regions may happen. Therefore, the preset numerical value is required to be set to be a numerical value less than a preset threshold herein, to prevent blurry transition.

In an embodiment, the step S500 of, according to each of the second exposed-image fusion-weight diagrams, performing image-fusion processing to the plurality of exposed images, to obtain the fused image includes:

according to the fusion weights corresponding to the pixel points in each of the second exposed-image fusion-weight diagrams, performing weighted summation to the plurality of exposed images, to obtain the fused image.

Particularly, by using the second exposed-image fusion-weight diagrams obtained in the above-described method including the overall characteristics of each of the overexposed images and the characteristic information of the different overexposed regions of each of the overexposed images, a weighted summation is performed to the exposed images, to obtain a fused image. Such an operation can sufficiently take the characteristics of each of the overexposed images under consideration, and balance the characteristics of the different overexposed regions in each of the overexposed images at the same time, prevent the missing of the details of the small overexposed regions, and maintain the texture information of the small overexposed regions, to obtain a fused image that is more realistic.

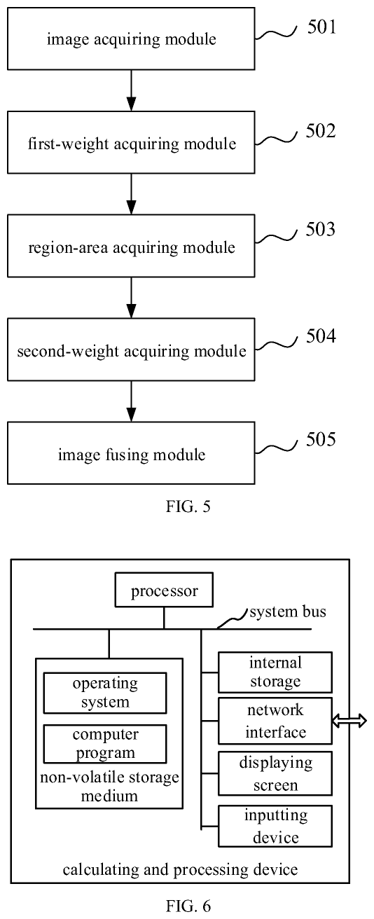

In an embodiment, as shown in FIG. 5, an image-fusion apparatus is provided, wherein the image-fusion apparatus includes: an image acquiring module 501, a first-weight acquiring module 502, a region-area acquiring module 503, a second-weight acquiring module 504 and an image fusing module 505, wherein:

the image acquiring module 501 is configured for, based on a same one target scene, acquiring a plurality of exposed images of different exposure degrees;

the first-weight acquiring module 502 is configured for acquiring a first exposed-image fusion-weight diagram corresponding to each of the exposed images, wherein the first exposed-image fusion-weight diagram includes fusion weights corresponding to pixel points of the exposed image;

the region-area acquiring module 503 is configured for acquiring a region area of each of overexposed regions in each of the exposed images;

the second-weight acquiring module 504 is configured for, for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and

the image fusing module 505 is configured for, according to each of the second exposed-image fusion-weight diagrams, performing image-fusion processing to the plurality of exposed images, to obtain a fused image.

In an embodiment, the first-weight acquiring module 502 is further configured for, for each of the exposed images, according to differences between pixel values of the pixel points of the exposed image and a preset reference pixel value, obtaining the first exposed-image fusion-weight diagram.

In an embodiment, the first-weight acquiring module 502 is further configured for calculating the differences between the pixel values of the pixel points of the exposed image and the preset reference pixel value; and according to ratios of the differences to the preset reference pixel value, obtaining the first exposed-image fusion-weight diagram, wherein if the difference corresponding to a pixel point in the exposed image is larger, the fusion weight corresponding to the pixel point in the first exposed-image fusion-weight diagram is lower.

In an embodiment, the region-area acquiring module 503 is further configured for performing overexposed-region detection to each of the exposed images, to obtain an overexposed-region mask diagram corresponding to each of the exposed images; according to each of the overexposed-region mask diagrams, performing region segmentation to the exposed image corresponding to the overexposed-region mask diagram, to obtain a corresponding overexposed region; and acquiring a region area of each of the overexposed regions in each of the exposed images.

In an embodiment, the second-weight acquiring module 504 is further configured for, according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

In an embodiment, the second-weight acquiring module 504 is further configured for, according to the correspondence relation, obtaining smoothing coefficients corresponding to the region areas of each of the overexposed regions in the exposed image; and according to the smoothing coefficients corresponding to the region areas of each of the overexposed regions in the exposed image, performing smoothing filtering to the first exposed-image fusion-weight diagram corresponding to the exposed image, to obtain a second exposed-image fusion-weight diagram corresponding to the exposed image.

In an embodiment, the second-weight acquiring module 504 is further configured for, by using a preset numerical value as a filtering radius, performing smoothing filtering to the second exposed-image fusion-weight diagram, to obtain a second updated exposed-image fusion-weight diagram, wherein the preset numerical value is less than a preset threshold.

In an embodiment, the image fusing module 505 is further configured for, according to the fusion weights corresponding to the pixel points in each of the second exposed-image fusion-weight diagrams, performing weighted summation to the plurality of exposed images, to obtain the fused image.

The particular limitations of the image-fusion apparatus can refer to the above limitations of the image-fusion method, and are not discussed here further. The modules of the above-described image-fusion apparatus may be implemented entirely or partially by software, hardware and a combination thereof. The modules may be embedded into or independent of a processor in a computer device in the form of hardware, and may also be stored in a memory in a computer device in the form of software, to facilitate the processor to invoke and execute the operations corresponding to the modules.

Each component embodiment of the present application may be implemented by hardware, or by software modules that are operated on one or more processors, or by a combination thereof. A person skilled in the art should understand that some or all of the functions of some or all of the components of the computing and processing device according to the embodiments of the present application may be implemented by using a microprocessor or a digital signal processor (DSP) in practice. The present application may also be implemented as apparatus or device programs (for example, computer programs and computer program products) for implementing part of or the whole of the method described herein. Such programs for implementing the present application may be stored in a computer-readable medium, or may be in the form of one or more signals. Such signals may be downloaded from an Internet website, or provided on a carrier signal, or provided in any other forms.

In an embodiment, there is provided a computing and processing device, wherein the computing and processing device may be a terminal, and its internal structural diagram may be shown in FIG. 6. The computing and processing device includes a processor, a memory, a network interface, a display screen and an inputting device that are connected by a system bus. The processor of the computing and processing device is used for providing the capacity of calculation and controlling. The memory of the computing and processing device includes a non-volatile storage medium and an internal storage. The non-volatile storage medium stores an operating system and a computer program code. Those program codes may be read from one or more computer program products or be written into the one or more computer program products. Those computer program products include program code carriers such as a hard disk, a compact disk (CD), a memory card or a floppy disk. The internal storage provides the environment for the running of the operating system and the computer program in the non-volatile storage medium. The network interface of the computing and processing device is used to communicate with an external terminal via a network connection. The computer program, when executed by a processor, implements the image-fusion method. The display screen of the computing and processing device may be a liquid-crystal display screen or an electronic-ink display screen. The inputting device of the computing and processing device may be a touching layer covering the display screen, may also be a press key, a trackball or a touchpad provided at the housing of the computing and processing device, and may also be an externally connected keyboard, touchpad, mouse and so on.

A person skilled in the art can understand that the structure shown in FIG. 6 is merely a block diagram of part of the structures relevant to the solutions of the present application, and does not form a limitation on the computing and processing device to which the solutions of the present application are applied, and the particular computer device may include components more or less than those shown in the figure or a combination of some of the components, or has a different arrangement of the components.

In an embodiment, a computing and processing device is provided, wherein the computing and processing device includes a memory and a processor, the memory stores a computer program, the computer program includes a computer-readable code, and the processor, when executing the computer program, implements the following steps:

based on a same one target scene, acquiring a plurality of exposed images of different exposure degrees;

acquiring a first exposed-image fusion-weight diagram corresponding to each of the exposed images, wherein the first exposed-image fusion-weight diagram includes fusion weights corresponding to pixel points of the exposed image;

acquiring a region area of each of overexposed regions in each of the exposed images;

for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and

according to each of the second exposed-image fusion-weight diagrams, performing image-fusion processing to the plurality of exposed images, to obtain a fused image.

In an embodiment, the processor, when executing the computer program, further implements the following steps: for each of the exposed images, according to differences between pixel values of the pixel points of the exposed image and a preset reference pixel value, obtaining the first exposed-image fusion-weight diagram.

In an embodiment, the processor, when executing the computer program, further implements the following steps: calculating the differences between the pixel values of the pixel points of the exposed image and the preset reference pixel value; and according to ratios of the differences to the preset reference pixel value, obtaining the first exposed-image fusion-weight diagram, wherein if the difference corresponding to a pixel point in the exposed image is higher, the fusion weight corresponding to the pixel point in the first exposed-image fusion-weight diagram is lower.

In an embodiment, the processor, when executing the computer program, further implements the following steps: performing overexposed-region detection to each of the exposed images, to obtain an overexposed-region mask diagram corresponding to each of the exposed images; according to each of the overexposed-region mask diagrams, performing region segmentation to the exposed image corresponding to the overexposed-region mask diagram, to obtain a corresponding overexposed region; and acquiring a region area of each of overexposed regions in each of the exposed images.

In an embodiment, the processor, when executing the computer program, further implements the following steps: according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

In an embodiment, the processor, when executing the computer program, further implements the following steps: according to the correspondence relation, obtaining smoothing coefficients corresponding to the region areas of each of the overexposed regions in the exposed image; and according to the smoothing coefficients corresponding to the region areas of each of the overexposed regions in the exposed image, performing smoothing filtering to the first exposed-image fusion-weight diagram corresponding to the exposed image, to obtain a second exposed-image fusion-weight diagram corresponding to the exposed image.

In an embodiment, the processor, when executing the computer program, further implements the following steps: by using a preset numerical value as a filtering radius, performing smoothing filtering to the second exposed-image fusion-weight diagram, to obtain a second updated exposed-image fusion-weight diagram, wherein the preset numerical value is less than a preset threshold.

In an embodiment, the processor, when executing the computer program, further implements the following steps: according to the fusion weights corresponding to the pixel points in each of the second exposed-image fusion-weight diagrams, performing weighted summation to the plurality of exposed images, to obtain the fused image.

In an embodiment, a computer-readable storage medium is provided, storing a computer program, wherein the computer program, when executed by a processor, implements the following steps:

based on a same one target scene, acquiring a plurality of exposed images of different exposure degrees;

acquiring a first exposed-image fusion-weight diagram corresponding to each of the exposed images, wherein the first exposed-image fusion-weight diagram includes fusion weights corresponding to pixel points of the exposed image;

acquiring a region area of each of overexposed regions in each of the exposed images;

for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and

according to each of the second exposed-image fusion-weight diagrams, performing image-fusion processing to the plurality of exposed images, to obtain a fused image.

In an embodiment, the computer program, when executed by the processor, further implements the following steps: for each of the exposed images, according to differences between pixel values of the pixel points of the exposed image and a preset reference pixel value, obtaining the first exposed-image fusion-weight diagram.

In an embodiment, the computer program, when executed by the processor, further implements the following steps: calculating the differences between the pixel values of the pixel points of the exposed image and the preset reference pixel value; and according to ratios of the differences to the preset reference pixel value, obtaining the first exposed-image fusion-weight diagram, wherein if the difference corresponding to a pixel point in the exposed image is larger, the fusion weight corresponding to the pixel point in the first exposed-image fusion-weight diagram is lower.

In an embodiment, the computer program, when executed by the processor, further implements the following steps: performing overexposed-region detection to each of the exposed images, to obtain an overexposed-region mask diagram corresponding to each of the exposed images; according to each of the overexposed-region mask diagrams, performing region segmentation to the exposed image corresponding to the overexposed-region mask diagram, to obtain a corresponding overexposed region; and acquiring a region area of each of overexposed regions in each of the exposed images.

In an embodiment, the computer program, when executed by the processor, further implements the following steps: according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

In an embodiment, the computer program, when executed by the processor, further implements the following steps: according to the correspondence relation, obtaining smoothing coefficients corresponding to the region areas of each of the overexposed regions in the exposed image; and according to the smoothing coefficients corresponding to the region areas of each of the overexposed regions in the exposed image, performing smoothing filtering to the first exposed-image fusion-weight diagram corresponding to the exposed image, to obtain a second exposed-image fusion-weight diagram corresponding to the exposed image.

In an embodiment, the computer program, when executed by the processor, further implements the following steps: by using a preset numerical value as a filtering radius, performing smoothing filtering to the second exposed-image fusion-weight diagram, to obtain a second updated exposed-image fusion-weight diagram, wherein the preset numerical value is less than a preset threshold.

In an embodiment, the computer program, when executed by the processor, further implements the following steps: according to the fusion weights corresponding to the pixel points in each of the second exposed-image fusion-weight diagrams, performing weighted summation to the plurality of exposed images, to obtain the fused image.

A person skilled in the art can understand that all or some of the processes of the methods according to the above embodiments may be implemented by relative hardware according to an instruction from a computer program, the computer program may be stored in a nonvolatile computer-readable storage medium, and the computer program, when executed, may contain the processes of the embodiments of the method stated above. Any reference to a memory, a storage, a database or another medium used in the embodiments of the present application may include a non-volatile and/or volatile memory. The nonvolatile memory may include a read-only memory (ROM), a programmable ROM (PROM), an electrically programmable ROM (EPROM), an electrically erasable programmable ROM (EEPROM) or a flash memory. The volatile memory may include a random access memory (RAM) or an external cache memory. By way of explanation rather than limitation, the RAM may be implemented in various forms, such as a static RAM (SRAM), a dynamic RAM (DRAM), a synchronous DRAM (SDRAM), a double-data-rate SDRAM (DDRSDRAM), an enhanced SDRAM (ESDRAIVI), a Synchlink DRAM (SLDRAM), a Rambus direct RAM (RDRAM), a direct-memory-bus dynamic RAM (DRDRAM), a memory-bus dynamic RAM (RDRAM) and so on.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

The technical features of the above embodiments may be combined randomly. In order to simplify the description, all of the feasible combinations of the technical features of the above embodiments are not described. However, as long as the combinations of those technical features are not contradictory, they should be considered as falling within the scope of the description.

The above embodiments merely describe some embodiments of the present application, and although they are particularly and in detail described, they cannot be accordingly understood as limiting the patent scope of the present application. It should be noted that a person skilled in the art may make variations and improvements without departing from the concept of the present application, all of which fall within the protection scope of the present application. Therefore, the patent protection scope of the present application should be subject to the appended claims.

1. An image-fusion method, wherein the method comprises:
acquiring a plurality of exposed images with different exposure degrees based on a same target scene;
acquiring a first exposed-image fusion-weight diagram corresponding to each of the exposed images, wherein the first exposed-image fusion-weight diagram comprises fusion weights corresponding to various pixel points of the exposed image;
acquiring a region area of each overexposed region in each of the exposed images;
for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and
according to each of the second exposed-image fusion-weight diagrams, performing image-fusion processing to the plurality of exposed images, to obtain a fused image.

2. The method according to claim 1, wherein the step of acquiring the first exposed-image fusion-weight diagram corresponding to each of the exposed images comprises:
for each of the exposed images, according to differences between pixel values of the pixel points of the exposed image and a preset reference pixel value, obtaining the first exposed-image fusion-weight diagram.

3. The method according to claim 2, wherein the step of, according to the differences between the pixel values of the pixel points of the exposed image and the preset reference pixel value, obtaining the first exposed-image fusion-weight diagram comprises:
calculating the differences between the pixel values of the pixel points of the exposed image and the preset reference pixel value; and
according to ratios of the differences to the preset reference pixel value, obtaining the first exposed-image fusion-weight diagram, wherein the larger the difference corresponding to a pixel point in the exposed image is, the lower the fusion weight corresponding to the pixel point in the first exposed-image fusion-weight diagram is.

4. The method according to claim 1, wherein the step of acquiring the region area of each of the overexposed regions in each of the exposed images comprises:
performing overexposed-region detection to each of the exposed images, to obtain an overexposed-region mask diagram corresponding to each of the exposed images;
according to each of the overexposed-region mask diagrams, performing region segmentation to the exposed image corresponding to the overexposed-region mask diagram, to obtain a corresponding overexposed region; and
acquiring a region area of each of the overexposed regions in each of the exposed images.

5. The method according to claim 1, wherein the step of, by using the region area of each of the overexposed regions in the exposed image, performing smoothing filtering to the first exposed-image fusion-weight diagram corresponding to the exposed image, to obtain the second exposed-image fusion-weight diagram corresponding to the exposed image comprises:
according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

6. The method according to claim 5, wherein the step of, according to the preset correspondence relation between the areas of the overexposed regions and the smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image comprises:
according to the correspondence relation, obtaining smoothing coefficients corresponding to the region areas of each of the overexposed regions in the exposed image; and
according to the smoothing coefficients corresponding to the region areas of each of the overexposed regions in the exposed image, performing smoothing filtering to the first exposed-image fusion-weight diagram corresponding to the exposed image, to obtain the second exposed-image fusion-weight diagram corresponding to the exposed image.

7. The method according to claim 1, wherein before the step of, according to each of the second exposed-image fusion-weight diagrams, performing image-fusion processing to the plurality of exposed images, to obtain the fused image, the method further comprises:
by using a preset numerical value as a filtering radius, performing smoothing filtering to the second exposed-image fusion-weight diagram, to obtain a second updated exposed-image fusion-weight diagram, wherein the preset numerical value is less than a preset threshold.

8. The method according to claim 1, wherein the step of, according to each of the second exposed-image fusion-weight diagrams, performing image-fusion processing to the plurality of exposed images, to obtain the fused image comprises:
according to the fusion weights corresponding to the pixel points in each of the second exposed-image fusion-weight diagrams, performing weighted summation to the plurality of exposed images, to obtain the fused image.

9. (canceled)

10. A computing and processing device, wherein the computing and processing device comprises:
a memory storing a computer-readable code; and
one or more processors, wherein when the computer-readable code is executed by the one or more processors, the computing and processing device implements the image-fusion method, wherein the method comprises: acquiring a plurality of exposed images with different exposure degrees based on a same target scene;
acquiring a first exposed-image fusion-weight diagram corresponding to each of the exposed images, wherein the first exposed-image fusion-weight diagram comprises fusion weights corresponding to various pixel points of the exposed image;
acquiring a region area of each overexposed region in each of the exposed images;
for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and
according to each of the second exposed-image fusion-weight diagrams, performing image-fusion processing to the plurality of exposed images, to obtain a fused image.

11. A computer program, wherein the computer program comprises a computer-readable code, and when the computer-readable code is executed in a computing and processing device, the computer-readable code causes the computing and processing device to implement the image-fusion method, wherein the method comprises: acquiring a plurality of exposed images with different exposure degrees based on a same target scene;
acquiring a first exposed-image fusion-weight diagram corresponding to each of the exposed images, wherein the first exposed-image fusion-weight diagram comprises fusion weights corresponding to various pixel points of the exposed image;
acquiring a region area of each overexposed region in each of the exposed images;
for each of the exposed images, by using the region area of each of the overexposed regions in the exposed image, performing smoothing filtering to the first exposed-image fusion-weight diagram corresponding to the exposed image, to obtain a second exposed-image fusion-weight diagram corresponding to the exposed image; and
according to each of the second exposed-image fusion-weight diagrams, performing image-fusion processing to the plurality of exposed images, to obtain a fused image.

12. A computer-readable medium, wherein the computer-readable medium stores the computer program according to claim 11.

13. The computing and processing device according to claim 10, wherein the step of acquiring the first exposed-image fusion-weight diagram corresponding to each of the exposed images comprises:
for each of the exposed images, according to differences between pixel values of the pixel points of the exposed image and a preset reference pixel value, obtaining the first exposed-image fusion-weight diagram.

14. The computing and processing device according to claim 13, wherein the step of, according to the differences between the pixel values of the pixel points of the exposed image and the preset reference pixel value, obtaining the first exposed-image fusion-weight diagram comprises:
calculating the differences between the pixel values of the pixel points of the exposed image and the preset reference pixel value; and
according to ratios of the differences to the preset reference pixel value, obtaining the first exposed-image fusion-weight diagram, wherein the larger the difference corresponding to a pixel point in the exposed image is, the lower the fusion weight corresponding to the pixel point in the first exposed-image fusion-weight diagram is.

15. The computing and processing device according to claim 10, wherein the step of acquiring the region area of each of the overexposed regions in each of the exposed images comprises:
performing overexposed-region detection to each of the exposed images, to obtain an overexposed-region mask diagram corresponding to each of the exposed images;
according to each of the overexposed-region mask diagrams, performing region segmentation to the exposed image corresponding to the overexposed-region mask diagram, to obtain a corresponding overexposed region; and
acquiring a region area of each of the overexposed regions in each of the exposed images.

16. The computing and processing device according to claim 10, wherein the step of, by using the region area of each of the overexposed regions in the exposed image, performing smoothing filtering to the first exposed-image fusion-weight diagram corresponding to the exposed image, to obtain the second exposed-image fusion-weight diagram corresponding to the exposed image comprises:
according to a preset correspondence relation between areas of the overexposed regions and smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image.

17. The computing and processing device according to claim 16, wherein the step of, according to the preset correspondence relation between the areas of the overexposed regions and the smoothing coefficients, and the region area of each of the overexposed regions in the exposed image, performing smoothing filtering to the first exposed-image fusion-weight diagram corresponding to the exposed image, to obtain the second exposed-image fusion-weight diagram corresponding to the exposed image comprises:
according to the correspondence relation, obtaining smoothing coefficients corresponding to the region areas of each of the overexposed regions in the exposed image; and
according to the smoothing coefficients corresponding to the region areas of each of the overexposed regions in the exposed image, performing smoothing filtering to the first exposed-image fusion-weight diagram corresponding to the exposed image, to obtain the second exposed-image fusion-weight diagram corresponding to the exposed image.

18. The computing and processing device according to claim 10, wherein before the step of, according to each of the second exposed-image fusion-weight diagrams, performing image-fusion processing to the plurality of exposed images, to obtain the fused image, the method further comprises:
by using a preset numerical value as a filtering radius, performing smoothing filtering to the second exposed-image fusion-weight diagram, to obtain a second updated exposed-image fusion-weight diagram, wherein the preset numerical value is less than a preset threshold.

19. The computing and processing device according to claim 10, wherein the step of, according to each of the second exposed-image fusion-weight diagrams, performing image-fusion processing to the plurality of exposed images, to obtain the fused image comprises:
according to the fusion weights corresponding to the pixel points in each of the second exposed-image fusion-weight diagrams, performing weighted summation to the plurality of exposed images, to obtain the fused image.
